(19) United States
(12) Patent Application Publication
(10) Pub. No.: US 2012/0007481 A1
(43) Pub. Date: Jan. 12, 2012

(54) Washing Machine with Tub Having Thermally Insulating Insert

(75) Inventors: Mario FILIPPETTI, Campoformido (IT); Fiorella TRIVILLIN, Pordenone (IT); Monica CELOTTO, Motto di Livenza (IT)

(73) Assignee: ELECTROLUX HOME PRODUCTS CORPORATION N.V., Brussels (BE)

(21) Appl. No.: 13/150,632

(22) Filed: Jun. 1, 2011

(30) Foreign Application Priority Data
Jun. 1, 2010 (EP) 10164604.0

(51) Int. Cl. D06F 39/12; B29C 45/14; B29C 45/16

(52) U.S. Cl. 312/228; 264/250; 264/279

(57) ABSTRACT

A washing machine comprises a tub (10) including a shell (20) being delimited by a wall (25). The shell is molded as a single piece of polymeric material. The shell (20) includes at least one insert (30) connected to the wall (25). The insert (30) is realized in a material having a thermal conductivity lower than the thermal conductivity of the material forming the shell (20) in order to locally insulate the shell where the insert is located.

### CROSS-REFERENCE TO RELATED APPLICATION

This Application claims priority to European Application No. 10164604.0, filed on Jun. 1, 2010.

### BACKGROUND OF THE INVENTION

The present invention relates to a laundry washing machine including a tub adapted for housing a rotating drum inside which the washing/drying load is placed.

In the present application the expression “washing machine” is used to refer both to a “standard” washing machine, adapted mainly for washing and rinsing the laundry, and to a washer-drier, which is adapted for washing, rinsing, and also for drying the laundry.

In the field of household appliances, the need for energy savings and lowering of consumption is extremely felt. Indeed, it is important for manufacturers that their appliances are classified as belonging to a low consumption category, such as the European A, A+ or A++, due to the increasing awareness of customers on the impact that household appliances have on total energy consumption.

Therefore, in the field of washing machines producers are generally trying to suitably modify their products in order to meet the above mentioned needs.

A drawback of modifying/designing an appliance in order to minimize its consumption is that generally the same becomes more expensive due to the extra process steps generally required for its production and consequently the final price to be paid by the customer is higher. It is therefore critical to find a suitable compromise between the need of lowering the consumption and the final cost of the appliance; in particular, it is very important that the resultant cost should not be too high compared to the market's standards.

In DE 4332684, a washing machine with a tub for receiving a rotatably arranged washing drum is disclosed. In order to provide a tub having optimum thermal insulation, the tub is made hollow-walled or double-walled. The inner wall of the tub hollow body consists of a lye-resistant material. The thermal insulation is introduced into the cavity of this tub body.

Applicant has noted that, although in the washing machine disclosed in DE 4332684 energy saving is achieved due to the insulation sheet present around the whole tub when compared to the energy consumption of washing machine without such a layer, the tub itself is extremely complex (being hollow and formed by a multi-layered structure) and thus requires several expensive manufacturing steps.

In EP 0835729, it is disclosed to produce by an injection molding method a large-sized and quite heavy part of plastic material, the improved method according to the invention provides for localized zones to be created in which the thermal conductance of the part is higher in surface impressions in correspondence of the ejectors provided in the mould for the removal of the same part after it has been molded. In a preferred embodiment, the outer surface of the part has, in correspondence to the surface impressions, clusters of closed-bottom pits formed by grids of mini-ribs and arranged perpendicularly with respect to each other. The thickness of the part changes from a maximum value at the periphery of the cavity to a minimum value in correspondence of the bottom of a substantial part of said pits.

### SUMMARY OF SELECTED INVENTIVE ASPECTS

Applicant has found that, connecting to a washing machine tub an insert of insulating material, energy is saved in the heating and maintenance phases of the washing cycle by reducing thermal energy dispersions.

With the wording “a washing machine tub”, a tub suitable to be installed on a washing machines is meant, more generally machines in which in at least a phase of their working cycle heat dissipation takes place. In addition, the washing machine according to the present invention can be either of the front-loading type or of the top-loading type.

The washing machine considered in the present invention are those provided with a tub comprising at least a shell realized in polymeric materials; preferably this tub is a molded polymeric tub formed generally by two half shells which are joined together by any suitable means forming substantially a hollow cylinder. It has to be understood that the tub can be made of any number of shells as long as each shell is molded as an en bloc polymeric element. It is to be understood that additional elements can be attached to each shell during or after the molding of the shell itself, such as elements having a mechanical functions (e.g. a bearing to which the drum shaft is rotatably connected, etc), advantageously components generally made in metallic material or cast iron. These elements can be for example co-molded with the shell or attached to it after the molding process. The shell in any case can be considered to be molded as a single piece of polymeric material also if additional elements are attached/fixed thereto.

Each shell is delimited by an outer wall defining an inner and an outer surface which are opposite to each other.

Applicant has found that the energy is saved not only when an insert realized in a thermal insulating material is associated to the whole tub, but also in case such an insert is associated only to a portion of the tub. This reduces the costs of the construction of the tub itself minimizing at the same time the amount of material needed.

Therefore, according to the invention, the shell of the tub of the invention includes at least an insert of thermal insulating material, where the term “insert” means not only an element realized in a material having thermal insulating properties positioned in correspondence to a portion of the wall of the shell, but also a layer of thermal insulating material (for example a layer of thermal insulating paint) positioned in correspondence with a portion of or of the whole wall of the shell.

A material having thermal insulating properties means in the following a material having a thermal conductivity which is lower than the thermal conductivity of the material forming the shell.

According to a first aspect, the invention relates a washing machine including a tub comprising a shell delimited by a wall, the shell being molded as a single piece of polymeric material, the shell including at least an insert connected to the wall, the insert being realized in a material having a thermal conductivity lower than the thermal conductivity of the material forming the shell.

According to a second aspect, the invention relates to a method of production of a washing machine including a tub having a shell, comprising the steps of injecting in a mold a first polymeric material realizing the shell of the tub and a second polymeric material realizing an insert connected to the shell, so that the insert and the shell are co-molded, the second polymeric material having a thermal conductivity lower than the thermal conductivity of the first polymeric material forming the shell.

According to a third aspect, the invention relates to a different method of production of a washing machine including a tub having a shell, comprising the steps of providing in a mold an insert made of a second polymeric material, injecting in the mold a first polymeric material realizing the shell, so that the shell is over-molded on the insert, the second polymeric material having a thermal conductivity lower than the thermal conductivity of the first polymeric material forming the shell.

The presence of the insert allows a local insulation of the shell, enhancing the thermal resistivity in particular in those areas where the heat dissipation is greater.

In at least one of the aforesaid aspects, the present invention can have at least one of the following preferred characteristics.

Preferably, the insert is coupled to the shell by any of the following alternative methods: by mechanical fastening means, by gluing, by molding or by coating.

More preferably, the tub and the insert are co-molded.

According to a different preferred embodiment, the tub is over-molded on the insert.

According to a preferred embodiment, the insert might cover a portion of the inner surface and/or of the outer surface of the shell.

Alternatively or in addition, the insert can be partially embedded in the wall of the shell.

Even more preferably, the insert is completely embedded in the wall of the shell. In case of a thermal insulating insert located within the wall of the tub, the insert hinders the heat propagation from the inside (where heat is generated) to the outside of the tub, minimizing the heating of the tub material located radially external to the insert, i.e. the material located between the insert and the external surface of the wall of the tub. In this way, energy is saved and at the same time there is no reduction of the available space inside or outside the tub. Indeed, the space (i.e. volume) of a washing machine which is available between the drum and the tub or between the tub and the external casing of the washing machine is rather limited and kept to a minimum in order not to increase the overall dimensions of the washing machine itself. Therefore any additional element located in this volume is preferably undesired. Embedding the insert(s) in the tub wall therefore achieve the energy saving without reducing the available volume. According to a preferred embodiment, the insert is located within the wall of the tub in the proximity of the inner wall of the tub to maximize the above mentioned effect of minimizing the heated portion of material forming the wall of the tub located radially external to the insert.

Preferably, the thermal conductivity of the material forming the insert is between 0.05 and 0.001 W/(mK).

According to an alternative or additional characteristic, in a preferred embodiment, the tub includes a heating element fixed to the shell and the insert is positioned in correspondence to the heating element. The insert is preferably located in correspondence with the bottom of the shell, where dispersions are higher due to the presence of the hot washing water and ballast load. Preferably, but not necessarily, the step of providing an insert into the mold in the third aspect of the invention includes the steps of:
injecting in a mold a second polymeric material realizing an insert;
letting the second polymeric material solidify; and
injecting the first polymeric material after solidification of the second polymeric material.

In other words, in the over-molding process of the shell on the insert, the inserts can be either already provided inside the mold in their final shape (e.g. already molded and solidified) and on them the first polymeric material forming the shell is injected, or the molding of both the insert and the shell can be performed in the same mold in series, i.e. first the material forming the insert is injected, molded and let solidify and then on it the material forming the shell is in turn injected, molded and let solidify.

### BRIEF DESCRIPTION OF THE DRAWINGS

The invention will be better described below on the basis of the appended drawings. The figures show:

FIG. 1 is a simplified cross-section of a first embodiment of the tub of a front loading washing machine realized according to the invention;

FIG. 2 is a bottom view of the tub of FIG. 1;

FIG. 3 is an enlarged partial cross-section along the line A-A of the tub of FIG. 2;

FIG. 4 is a frontal view of the tub of FIG. 2 in a disassembled condition; and

FIGS. 5-9 are schematic cross-sections of five additional embodiments of tubs realized according to the invention.

FIG. 10 is a front perspective view of a front-load washing machine that may advantageously incorporate the inventive tub constructions shown in the previous figures.

In the figures, elements that are identical or that fulfill the same function bear the same reference numeral. In addition, the figures are in some cases oversimplified and elements are removed in order to enhance clarity of the same to better show and describe the present invention.

### DETAILED DESCRIPTION OF EXAMPLE EMBODIMENTS

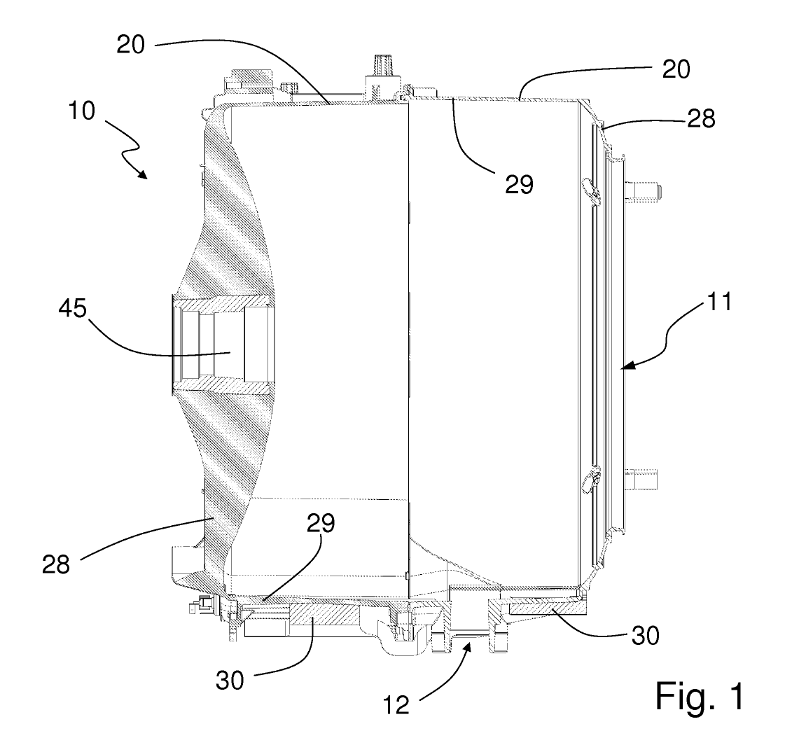

With initial reference to FIG. 1, with 10 a tub for a washing machine is globally indicated. Although in the appended figures a tub of a front loading washing machine is depicted, it is to be understood that the teaching of the invention applies also to combined washer-dryer both in the front loading and top loading configuration.

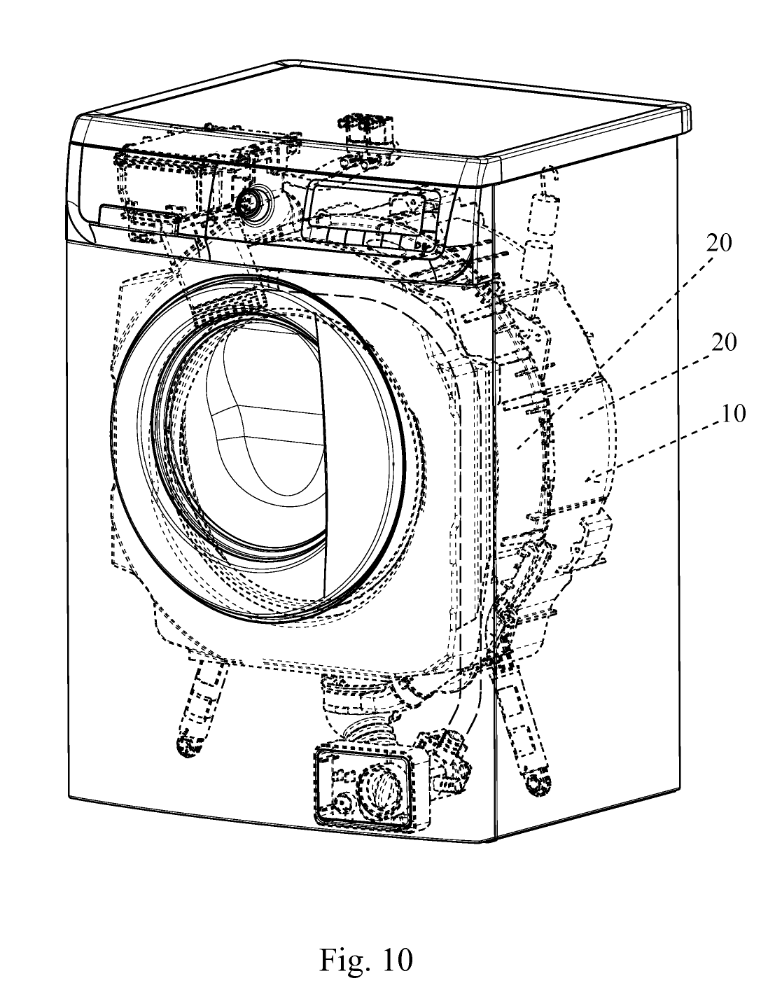

The remaining parts of the washing machine of the invention, in addition to tub 10, are considered to be known in the art and therefore are not further detailed. An example of a washing machine that may incorporate a tub construction in accordance with the invention is illustrated in FIG. 10.

The tub 10 includes a polymeric shell 20, preferably two (but they may be also more than two) polymeric shells. These shells (both indicated with 20 and visible in FIGS. 1, 2 and 10) are preferably molded by injection molding.

Each shell is an en bloc piece of polymeric material, i.e. it is molded as a single piece of plastic. The two shells 20, called forward shell and rear shell, are connected to each other for example by welding; alternatively they might include flanges which are bolted together or by any other suitable techniques. The two connected shells 20 form substantially a cylindrical hollow shape. Preferably, the connection of the rear and forward shell is watertight so that leaks do not appear during the washing or drying process of the machine in which the tub of the invention is mounted. In the interior of the cylinder defined by the two shells, coaxially with the cylinder so defined, the tub 10 bears and houses a drum (not shown) which is adapted to rotate around its axis and to contain the cloths to be washed/dried in the working cycle of the machine. Drum and motor assembly for the rotation of the same are commonly known parts in the industry and therefore are not further described. Additional elements, such as a bearing 45 for the drum shaft, made for example of metallic material, can be advantageously fixed to any of the shell(s) 20. These additional elements can be connected and/or fixed to the shell either during the molding process of the shell or after the molding phase.

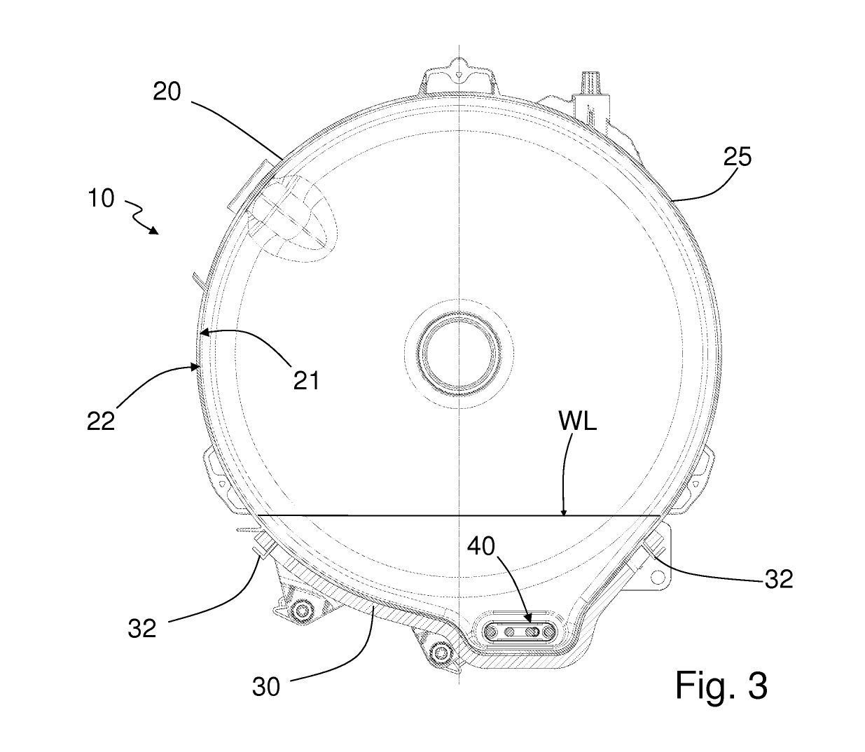

Each shell 20 is delimited by a wall 25 which defines an inner surface 21 which is facing the drum, not illustrated, during operation and an outer surface 22 opposite to the inner one. Wall 25 comprises a cylindrical envelope 29 having one end closed by a base 28 so that, when the two shells 20 are connected, the two bases 28 result one opposite to the other. In operation, the inner surface 21 is—in addition to the washing load—also in contact to washing liquids during the washing cycles (see for example FIG. 3 in which a “water level” WL, i.e. a level reached by the water during the washing cycle, is depicted). If in the description of a particular element of the shell 20 it is irrelevant whether the inner or the outer surface is meant, simply the term “surface of the shell” will be used to avoid redundancy.

In the case, illustrated in the enclosed figures, of a front loading washing machine, the forward shell 20 of the tub 10 comprises an opening 11 in correspondence of its base 28 to load and unload the clothes to be washed/dried.

In the case, not illustrated, of a top loading washing machine, the opening for the loading/unloading of the clothes is advantageously obtained in the cylindrical envelope 29 of one or more of the shells comprised in the tub 10.

Advantageously the tub 10 comprises an inlet and an outlet (one of which, the outlet 12, is shown in FIGS. 1 and 3) for the inlet of washing liquid and for the discharge of the same; said inlet and outlet are disposed preferably according to a standard tub configuration.

The plastic shell 20 is preferably realized in a thermoplastic polymer, and even more preferably in polypropylene, to which mechanical reinforcing agents or fillers (for example mineral or glass fibers) might be added. A material present in the market in which the shell 20 of the invention can be realized is for example Carboran®. The thermal conductivity of the material forming the shell 20 of the tub 10 of the invention is generally between 0.2 and 0.6 W/(mK).

According to the invention, the shell 20 includes at least one insert 30 realized in a material having a thermal conductivity which is lower than the thermal conductivity of the material forming the shell 20 and preferably said thermal conductivity is between 0.001 and 0.05 W/(mK). Preferred materials for the realization of the insert 30 are any one, or any combination, of the following: expanded or foamed polymers such as polyurethane, expanded polyolefins, expanded polystyrene, such as expanded Carboran® etc; or Vacuum Insulation Panels (VIP); or felts such as mineral/glass fibers, synthetic fibres, cellulosic materials, aerogels, etc; or bubble fils; or wood, etc, as long as they have insulating properties.

The insert 30 can be for example realized as follows: a polymeric material can be expanded or foamed by reaction of suitable ingredients (“blowing agents”) or of expanding additives included in the polymeric material formulation of the insert 30, for example by thermal treatment. Alternatively, an expansion gas can be added (i.e. injected) into the polymer composition, the gas partially solubilises into the polymer during the molding phase due to the high pressure step therein included and then the gas is released when the pressure drops inside the mold, thus generating bubbles and thereby expanding the polymer.

The shell 20 may include a single insert 30, a plurality of inserts of the same type (i.e. realized in the same material) or a plurality of inserts of different types (i.e. realized in different materials possibly having different thermal conductivities).

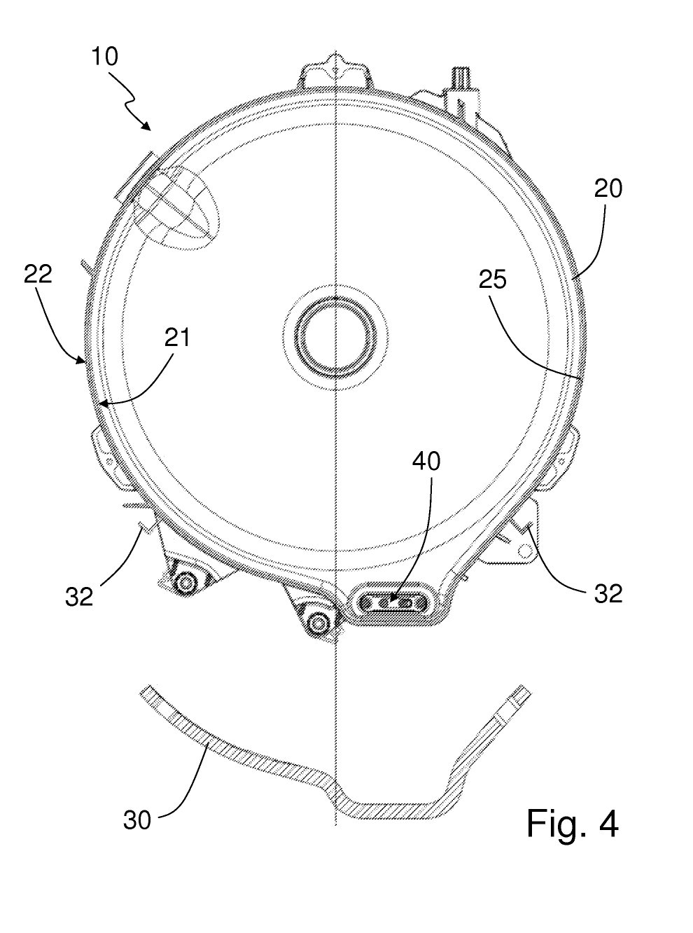

The insert 30 is fixed to the shell 20 and it is positioned preferably, but not necessarily, in correspondence with a heating element (see for example heating resistance 40 shown in FIGS. 3 and 4) connected to the tub 10. The insert 30 is preferably located in correspondence to the lower portion of the shell 20 (lower with respect to a vertical axis defined as the vertical axis of the washing machine when in use) which is in contact with the water to be heated during the washing process. However, the insert 30 can be located in any region of the tub 10. The insert 30 may advantageously have a plate-shape, i.e. it may be a layer of polymeric material which is shaped in order to follow the contour of the portion of shell wall 25 to which it is connected.

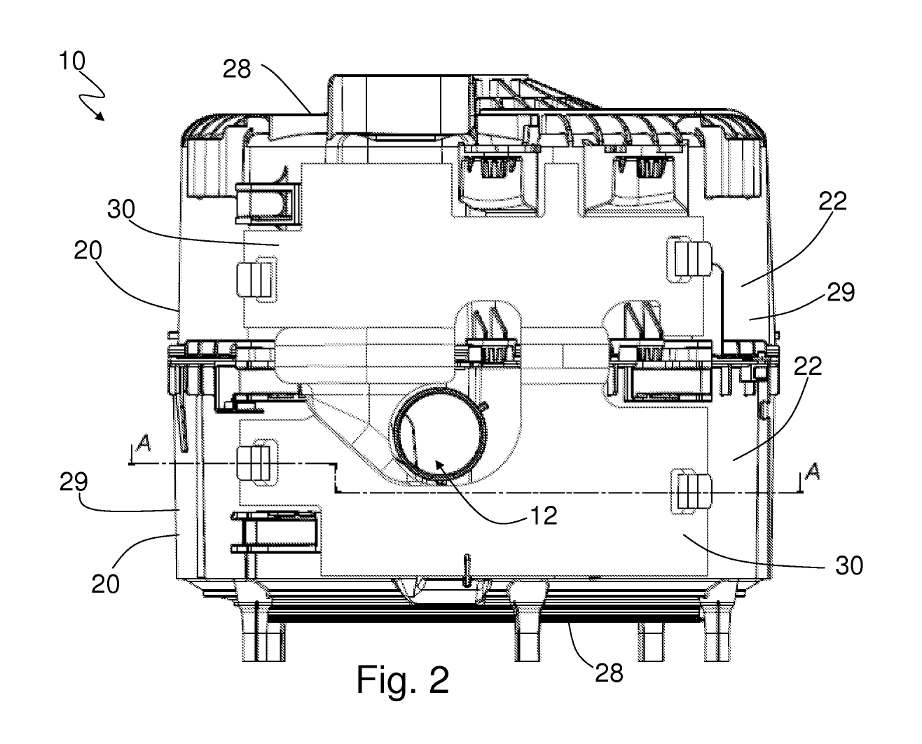

As a first example of an embodiment of the invention shown in FIGS. 2 and 3, the tub 10 is formed by two shells 20 and includes the single insert 30 located in the lower part of the tub 10 covering a portion of the outer surfaces 22 of both forward and rear shells 20 in correspondence to their cylindrical envelope 29. The insert 30 is fixed to the shells 20 via fastening means 32 such as screws, hooks, snap-fittings means, or the like.

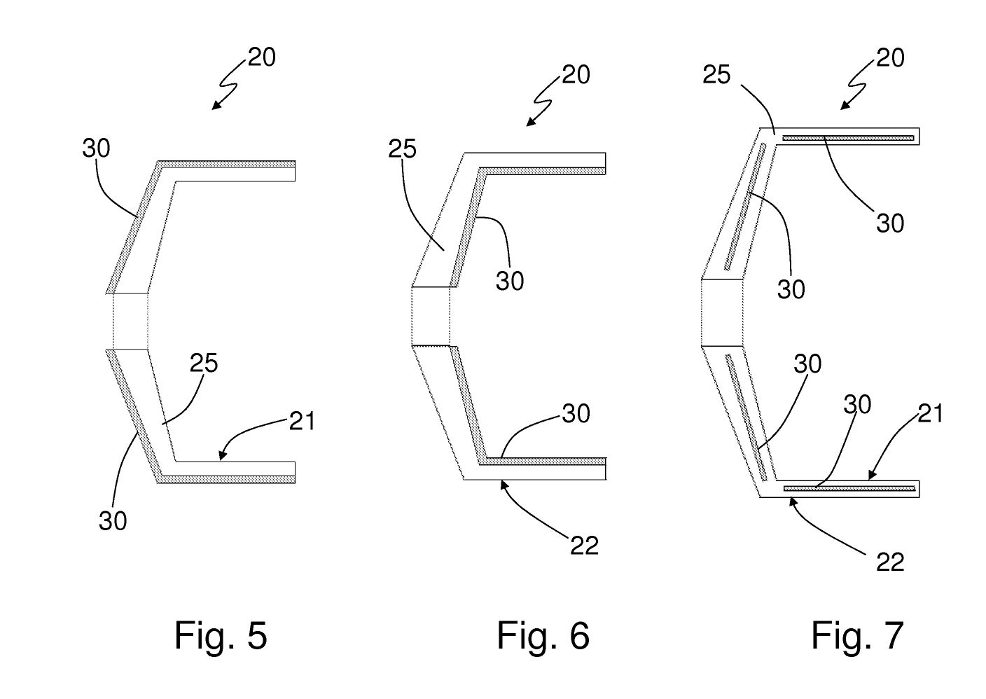

According to a different embodiment of the invention shown in FIGS. 5 and 6, the shell 20 might include one or more inserts 30 which can be fastened to the shell(s) 20 in correspondence to its outer 22 or inner surface 21 (although not shown in the mentioned figures, one or more inserts can be present both in the inner 21 and in the outer surface 22 of the shell 20), i.e. the insert 30 may be in contact with the inner and/or outer surface of the wall 25. The mentioned figures are simplified figures to better highlight the insert's location, therefore many detail of the tub 10 have been removed.

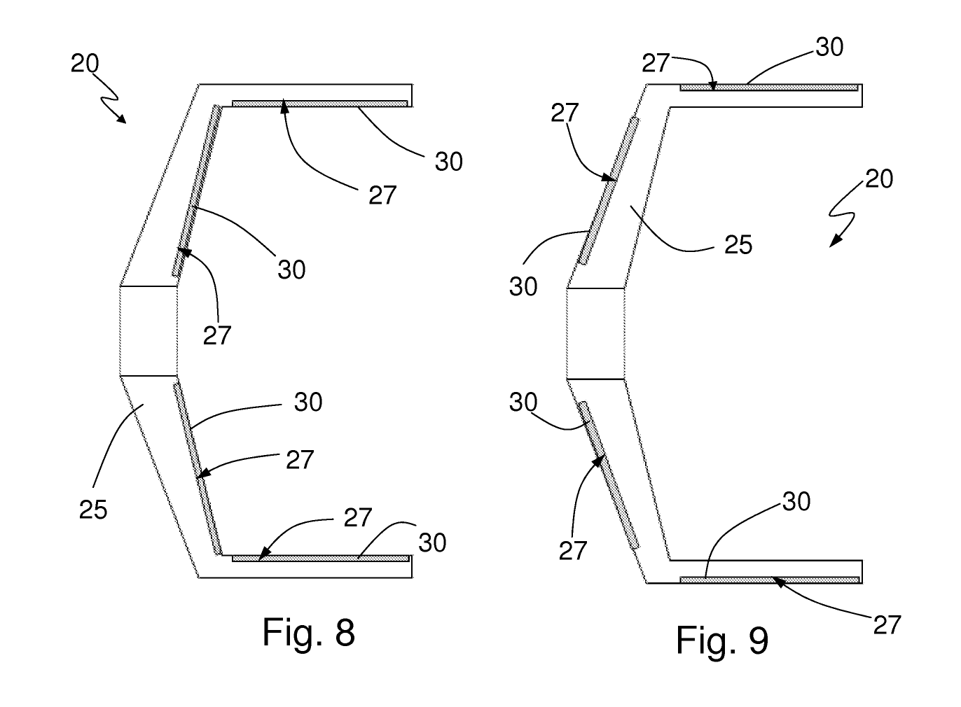

According to an additional different embodiment shown in FIGS. 8 and 9, in the inner and/or in the outer surface 21, 22 of the wall 25 of the shell 20, recesses 27 are realized, each of which is filled with an insert 30. It has to be understood that although in FIGS. 5-9 inserts are placed in correspondence with both the upper and the bottom part of the shell 20, they can be placed in correspondence with a single portion of it. In addition, a single insert can be present.

In addition to the fastenings between shell 20 and insert 30 described above in the different embodiments of the invention, i.e. fastening means such as screws or the realization of a recess 27 on the shell 20 where the insert is then rabbeted, according to a different embodiment of the invention, the insert can also be glued to the shell 20.

The connection between insert 30 and shell 20 can be obtained, according to alternative different embodiments of the invention, also using different processes than mechanical fastening or gluing, for example by molding.

In FIG. 7, an additional preferred embodiment of the invention is shown, where the inserts 30 (which can be a plurality of inserts or also a single insert) are embedded within the wall 25 of the shell 20. It has to be understood that each insert 30 can be completely embedded in the wall 25 or only partially, i.e. a portion of any of the insert 30 can surface in the inner and/or outer surface. More preferably, the insert 30 is completely embedded in the wall 25.

The tub of the washing machine according to the invention is preferably realized according to the following methods.

In a first preferred embodiment, the insert 30 is over-molded on the shell 20. The polymeric material forming the shell 20 is first injected into a mould cavity and then the material having insulating properties, for example preferably an expanded/expandable polymer, is later over-molded onto the solidified shell, in correspondence with a portion of the inner surface of the shell and/or in correspondence with a portion of the outer surface of the shell. Optionally, in order to create the recesses 27 in which the material forming the insert 30 can be injected, or for eventually let it complete its expansion, some movements or adjustments of the mold can be provided.

According to a second embodiment to realize the tub 10 of the invention, the polymeric material forming the shell 20 is over-molded on the polymeric material forming the insert 30. In a first variant of the over-molding embodiment of the method according to the invention, the material forming the insert 30 is injected into the mold first, the expansion and solidification phases take place, and then the material forming the shell of the tub of the invention is afterwards over-molded onto it. Also in this case, some adjustments or movements of the mold can be included.

In a variant of the over-molding embodiment of the method of the invention, the insert 30 is positioned in the mold already formed, e.g. already molded and solidified, and then the polymeric material forming the shell is injected.

In an additional embodiment of the invention, both the shell material and the insert material are co-injected into the mold and solidification of the two materials proceeds completely or at least partially in parallel, obtaining a co-molded shell 20/insert 30.

With the above mentioned three methods of production of the tub of the invention in which a molding process is used to couple the insert 30 to the shell 20, all embodiments shown in FIGS. 5, 6, 7, 8 and 9 can be realized.

In order to enhance the mutual adhesion of the shell and insert, in particular when the insert covers a portion of the inner and/or outer surface of the shell or is coated on the same, a surface treatment phase can be optionally performed either on the surface of the shell where the insert has to be applied or on the surface of the insert which comes into contact with the surface of the shell.

According to an additional different embodiment of the invention, the insert 30 is coated on the shell 20, i.e. either the shell (i.e. its outer and/or inner surface) is completely coated by the insert or only a portion of the same is coated. In this embodiment, the insert can be for example a paint, e.g. an Aerogel coating.

### Example 1

The tub 10 depicted in FIGS. 2 and 3 is realized in Carboran®, or polypropylene filled with mineral fibers-talc, calcium carbonate or metallic fibers or glass fibers and includes a single insert 30 mechanically fastened on the outer surfaces of the forward and rear shells 20. The insert is realized in expanded polyethylene having a thermal conductivity equal to 0.044 W/(mK) and a density of about 30-40 kg/m³.

### Example 2

The outer surface 22 of the shell 20 is coated using an Aerogel coating, which might cover the whole surface or only a portion of the same. The thermal conductivity of the coating is of about 0.017 W/(mK) and the thickness of the resulting insert 30 is of about 0.2 mm. The insert 30 can withstand temperatures in the range of −40° C.-125° C.

1. A washing machine comprising a tub including a shell being delimited by a wall, said shell being molded as a single piece of polymeric material, wherein said shell includes at least one insert connected to said wall, said insert being realized in a material having a thermal conductivity lower than the thermal conductivity of the material forming the shell, in order to locally insulate the shell where the insert is located.

2. The washing machine according to claim 1, wherein said insert includes an expanded and/or foamed polymeric material.

3. The washing machine according to claim 1, wherein said wall defines an inner and an outer surface, said insert covering a portion of said inner and/or of said outer surface.

4. The washing machine according to claim 1, wherein said insert is at least partially embedded in said wall.

5. The washing machine according to claim 4, wherein said insert is totally embedded into said wall.

6. The washing machine according to claim 1, wherein said insert is connected to said wall by mechanical fastening means and/or gluing.

7. The washing machine according to claim 1, wherein said insert and said shell are co-molded.

8. The washing machine according to claim 1, wherein said insert is over-molded on said shell.

9. The washing machine according to claim 1, wherein said shell is over-molded on said insert.

10. The washing machine according to claim 1, wherein said insert is coated on said shell.

11. The washing machine according to claim 1, wherein said wall includes a recess in which the insert is inserted.

12. The washing machine according to claim 1, further comprising a heating element, said insert being connected to said wall in correspondence to or in proximity of said heating element.

13. A method of production of a washing machine including a tub having a shell, comprising the steps of injecting in a mold a first polymeric material realizing the shell of the tub and a second polymeric material realizing an insert connected to said shell, so that said insert and said shell are co-molded, said second polymeric material having a thermal conductivity lower than the thermal conductivity of said first polymeric material forming the shell.

14. A method of production of a washing machine including a tub having a shell, comprising the steps of:
providing in a mold an insert made of a second polymeric material; and
injecting in said mold a first polymeric material realizing said shell, so that said shell is over-molded on said insert, said second polymeric material having a thermal conductivity lower than the thermal conductivity of said first polymeric material forming the shell.

15. A method according to claim 14, wherein the step of providing an insert in a mold includes the steps of:
injecting in a mold a second polymeric material realizing said insert;
letting the second polymeric material solidify; and
injecting said first polymeric material after solidification of said second polymeric material.
